(19) United States
(12) Patent Application Publication
(10) Pub. No.: US 2009/0300921 A1
(43) Pub. Date: Dec. 10, 2009

(54) LOTTERY TICKET SCRATCHER WITH LIGHT

(76) Inventors: Andrew STRICKMAN, Santa Rosa Beach, FL (US); Yvonne Goldman, Flowery Branch, GA (US)

Correspondence Address: BUCHANAN, INGERSOLL & ROONEY PC, POST OFFICE BOX 1404, ALEXANDRIA, VA, 22313-1404, US

(21) Appl. No.: 12/479,208

(22) Filed: Jun. 5, 2009

Related U.S. Application Data
(60) Provisional application No. 61/059,520, filed on Jun. 6, 2008.

(51) Int. Cl. B26B 3/00

(52) U.S. Cl. 30/169

(57) ABSTRACT

A combination lottery ticket scratcher and light that can be in the shape of a icon, such as animals, mythological creatures, religious figures, symbols of luck, greed, sports teams, or other interest or affinities, etc. The lighted scratcher optionally has a key chain or other securing attachment and/or a brush, particularly for bearded characters or characters depicted as having many teeth. The light (e.g., one or more LEDs or light bulbs) projects light onto the end or work area of the lottery ticket scratcher. The light can represent a part of the character, such as the eyes, flame of a dragon, etc., can be colored to any color, have multiple colors or time varying colors, or project white or black light, or combinations thereof. The light can be activated by the user via a switch (e.g., push, squeeze, slide, etc.) or activated when the scratching tool is engaged with a surface during a scratching or scraping operation. The icon can symbolize good luck or good fortune, can be symbols of birth years, mascots, religious figures, mythical figures, or nearly an other character of interest to a potential user. The lighted lottery scratcher can be sold in combination with a gift pack of lottery tickets, for example.

Priority is claimed to U.S. Provisional Patent Application No. 61/059,520 entitled “Lottery Ticket Scratcher with Light”, filed Jun. 6, 2008, herein incorporated by reference for all purposes.

### BACKGROUND

This invention relates, in general, to lighted lottery ticket scratchers optionally shaped to be in the form of a character.

### DESCRIPTION OF THE PRIOR ART

Some people find great joy or fulfillment of a desire in the act of buying a lottery ticket and scratching off the surface layer covering the lottery numbers or other indicia. There are a large number of types of games that use lottery tickets, and used as herein, the term lottery ticket should be understood to encompass any substrate on which indicia appears, at least some of which are covered by an opaque film or coating that can be scratched off to expose indicia printed underneath. Winning a lottery is of course exciting, but the mere chance of winning is enough to draw a large segment of the population to buy lottery tickets of any number of types and games.

Typically, a lottery ticket owner will use a tool of convenience, such as a coin. There have been attempts to design dedicated lottery ticket tools, such as seen in U.S. Pat. No. Des. 290,056 to Hatfield, U.S. Pat. No. Des. 311,980 to Baker, U.S. Pat. No. Des. 353,239 to Brisco, U.S. Pat. No. 5,713,232 to Hodge, U.S. Pat. No. Des. 552,316 to Block et al, U.S. Pat. No. Des. 558, 945 to Bell, and US 2002/0152572 to Steinmetz et al.

### SUMMARY OF THE INVENTION

Various embodiments of an icon lottery ticket scratcher are disclosed herein. The icon scratcher of certain embodiments has a finger-grip body having a first end and a second end, a scratching tool positioned (e.g., a curved or straight edge) adjacent the first end, and a light positioned at the first end. The light is positioned to project light in a working space adjacent to the scratching tool. The finger-grip body can optionally bear the shape (resemblance) of an icon (i.e., a recognizable symbol representing something), such as by way of non-limiting examples a symbol of luck, a symbol of fortune, a symbol of greed, a symbol of a year of birth, a religious symbol, a mythical symbol, a sports mascot or logo, or virtually any other symbol with which a user might have an affinity (e.g., dogs, cats and other pets of various breeds, farm animals, cartoon characters, famous and infamous people or other characters, but also non-animated symbols, such as dollar signs (or other currency), poker chips, four leaf clovers, etc.).

The light can be an LED or an incandescent, neon or fluorescent light bulb, or any other form of light emitting device that can be housed in a hand-held device. The light can, for instance, be a pair of LEDs positioned to be the eyes of a character, and can be activated by any suitable form of switch, such as a slide switch, push switch, a squeeze switch, or by a pressure activated switch activated by engaging the scratching tool on a surface, or combinations thereof.

The lottery ticket scratcher can optionally include an attachment portion for attaching a key chain at the second end, and/or an attachment portion for attaching a lanyard at the second end.

The lottery ticket scratcher can also optionally include a plurality of bristles or a brush or other flexible material at one of the first second ends, and the bristles may be made to look like facial hair of the character, teeth of the character, wings of a character, and a tail of the character, to name a few examples.

Additionally, embodiments can include a combination of the lighted lottery ticket scratcher, a plurality of lottery tickets, and a package for securing said lottery ticket scratcher and one or more lottery tickets together, such as a package or pouch for holding lottery tickets to which the lottery ticket scratcher is attached by a chain or lanyard, and/or the package can hold one or more lottery tickets and the lottery ticket scratcher.

### BRIEF DESCRIPTION OF THE DRAWINGS

FIGS. 1-7 show an exemplary embodiment though perspective side, front, top, rear and bottom views.

FIGS. 8-14 show another exemplary embodiment of a disclosed poker chip lottery scratcher through perspective side, front, rear, top and bottom views.

FIGS. 15-20 show yet another exemplary embodiment of a disclosed alligator head lottery scratcher through perspective front, left side, right side, top and rear views.

FIGS. 21-26 show another exemplary embodiment of a disclosed bull dog lottery scratcher through perspective, right side, left side, front, rear and top views.

### DESCRIPTION OF THE PREFERRED EMBODIMENT

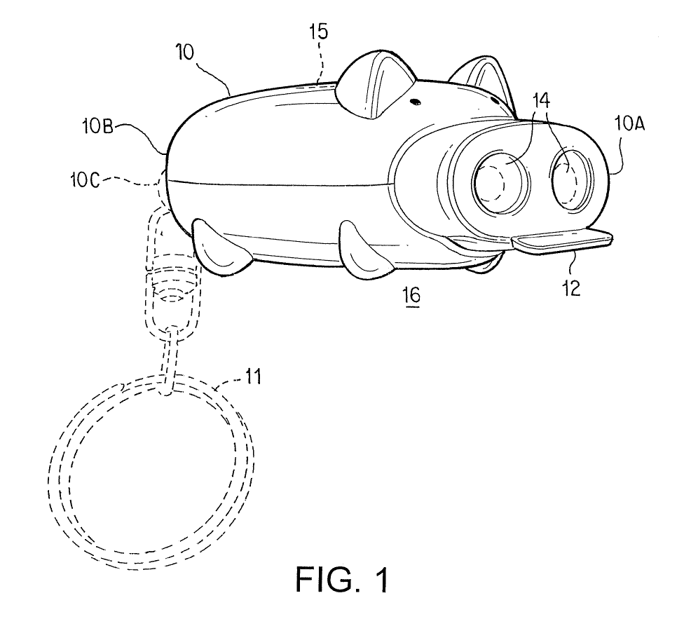

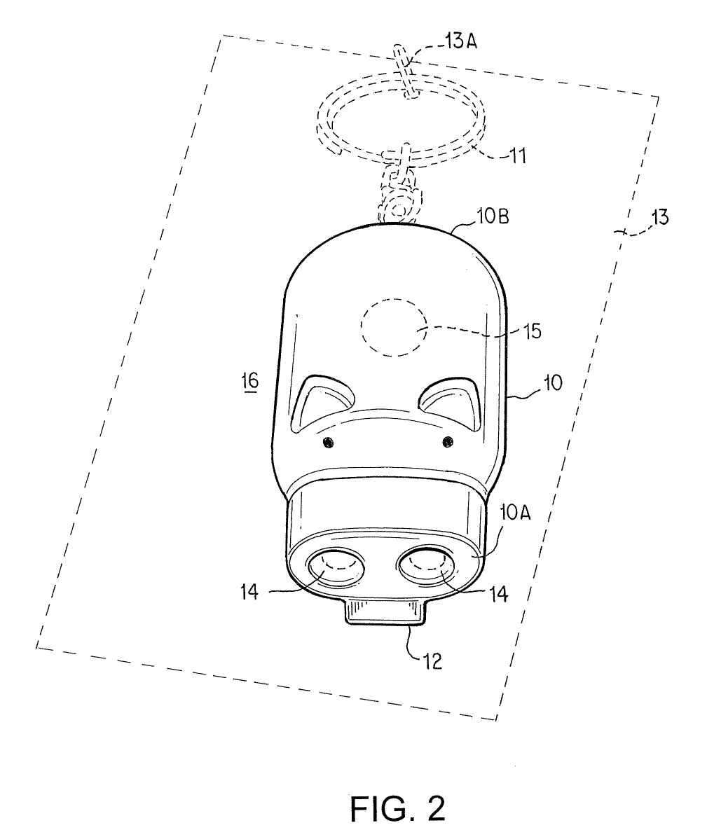

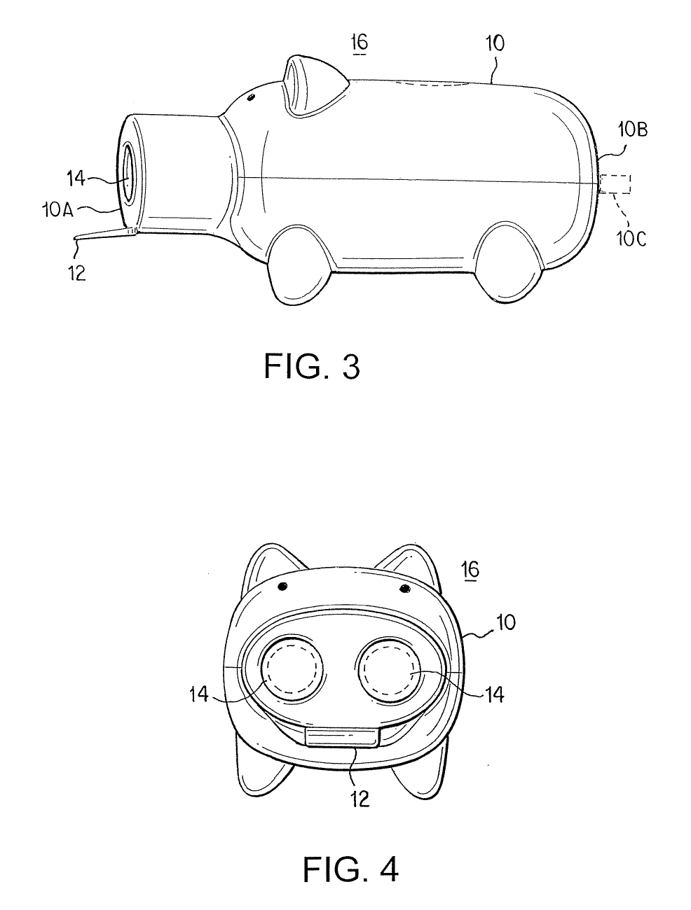

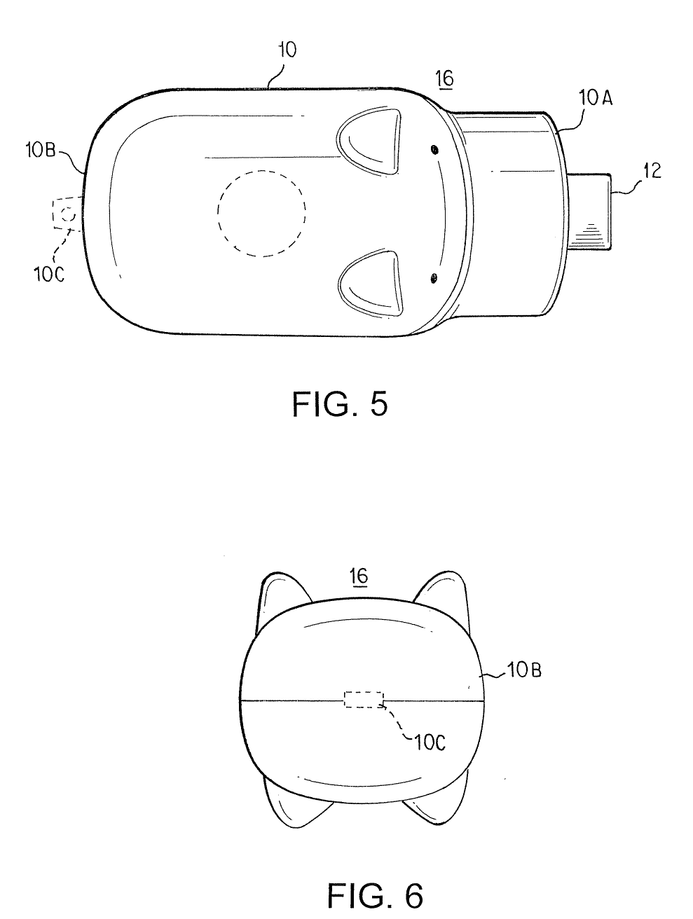

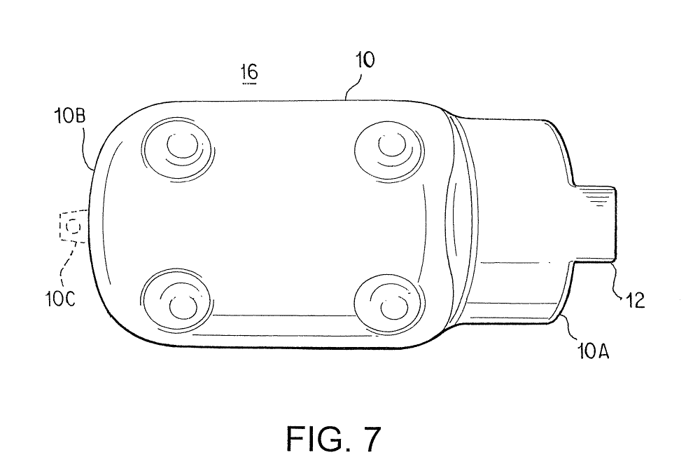

With reference to the accompanying figures, various embodiments of a caricatured lottery ticket scratcher with light will be described. For example, FIGS. 1-7 each include a finger-grip body 10 having a first end 10A and a second end 10B. The finger-grip body 10 can be have a length, width and height within a broad range, but preferably should be dimensioned to be comfortable for a person to grip with his or her fingers and impose a scratching action on a lottery ticket of sufficient pressure to scratch off an opaque film or coating on the substrate of the ticket. A scratching tool 12 is positioned adjacent the first end 10A. The scratching tool 12 in this embodiment of FIG. 3 is perpendicular to the body 10, but it could be at an angle or parallel to the finger-grip body 10. A light 14 source (i.e., with one or more lighting elements) is positioned at the first end 10A, and is positioned to project light in a working space adjacent the scratching tool 12. When activated, and with the scratching tool 12 engaged with a surface of a lottery ticket, a user will be able to see the lottery ticket, or a portion thereof, in order to see where to scratch, as well as the numbers or other indicia that make-up a lottery game as the opaque coating is scratched off. Of course, the light 14 from the light source can project into space and be useful as a miniature flashlight.

It should be noted that the lottery ticket can embody any game of chance or any other form of game or selective information dissemination that involves covering indicia of whatever form with an opaque film that can be scratched off. Upon being scratched off, the underlying indicia can be viewed by the user, and there is evidence from the removal of the opaque film of the user's activity in this regard.

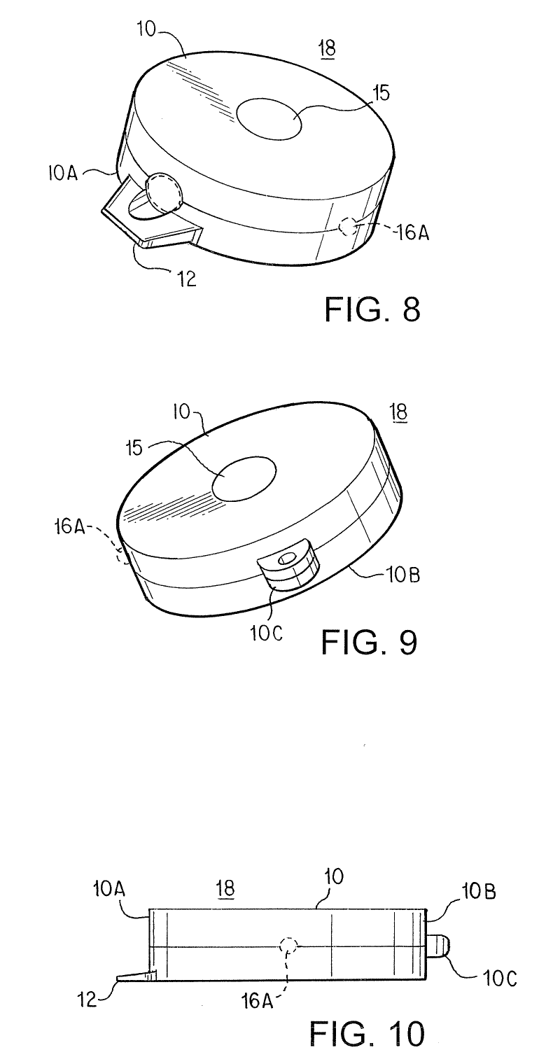

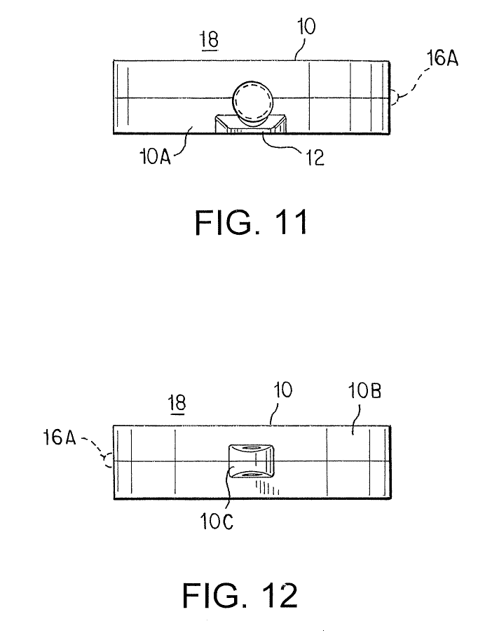

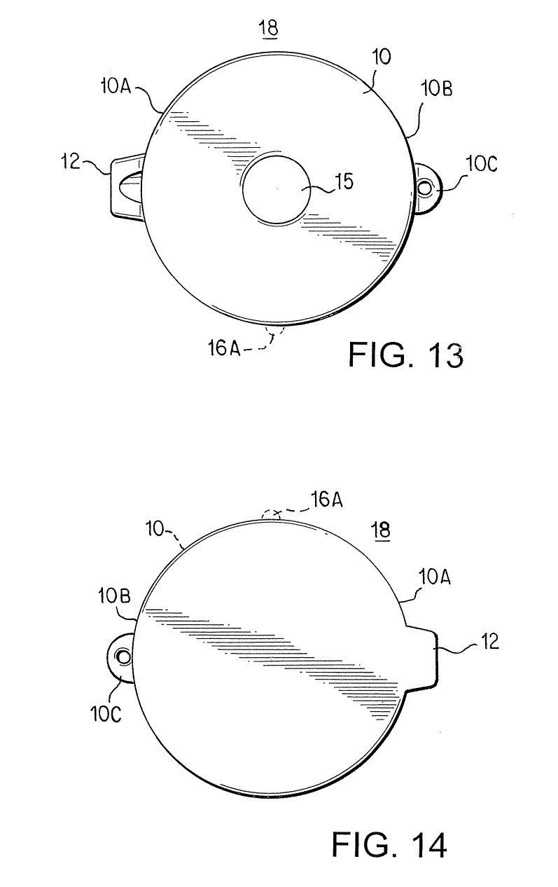

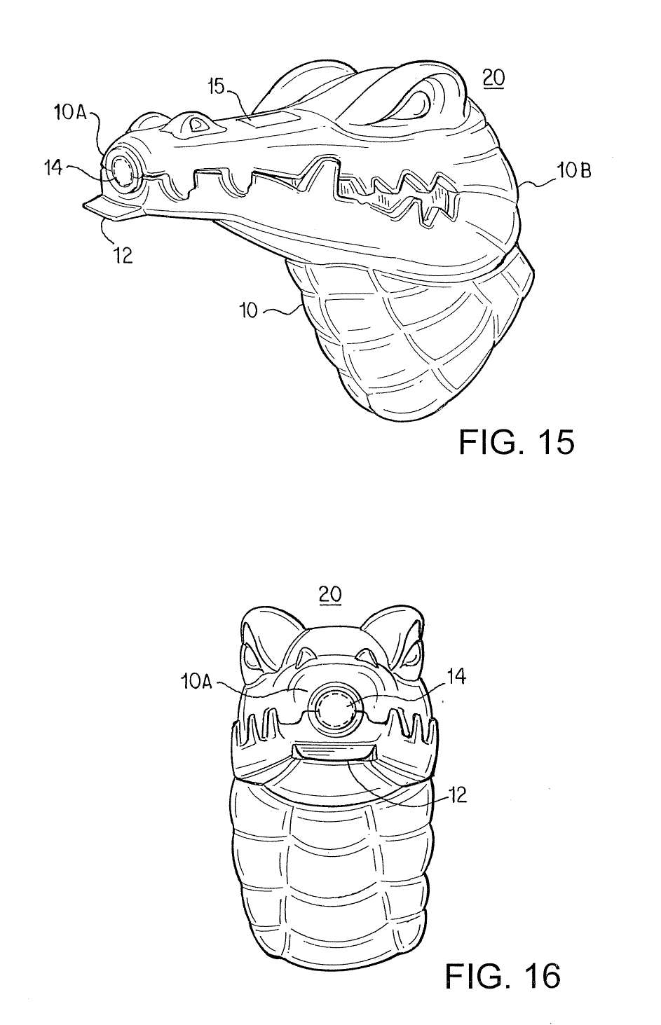

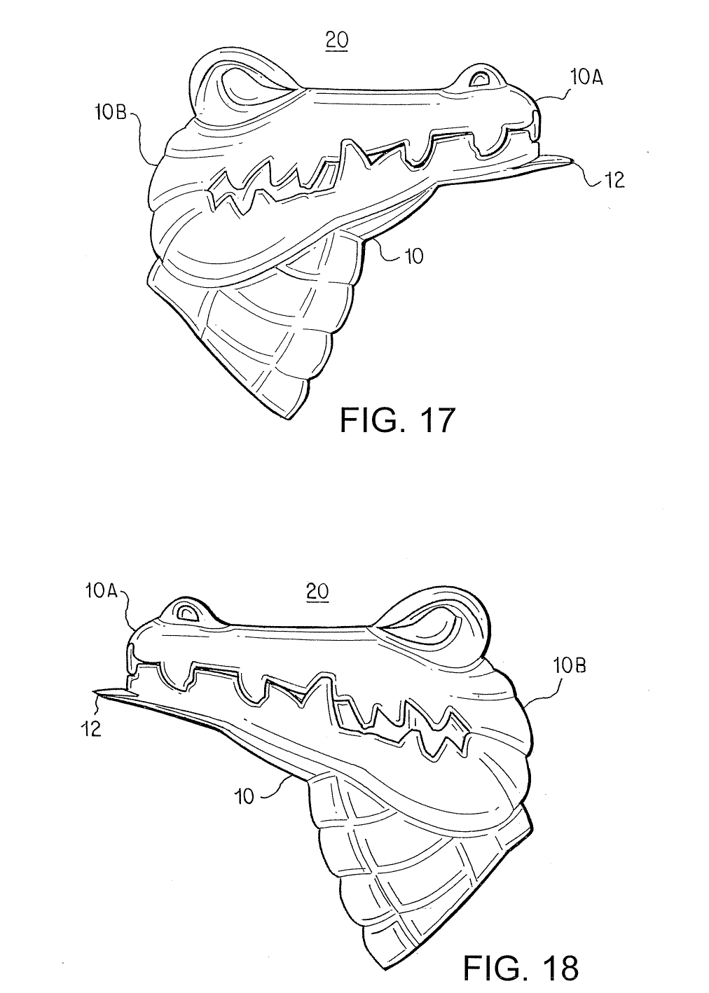

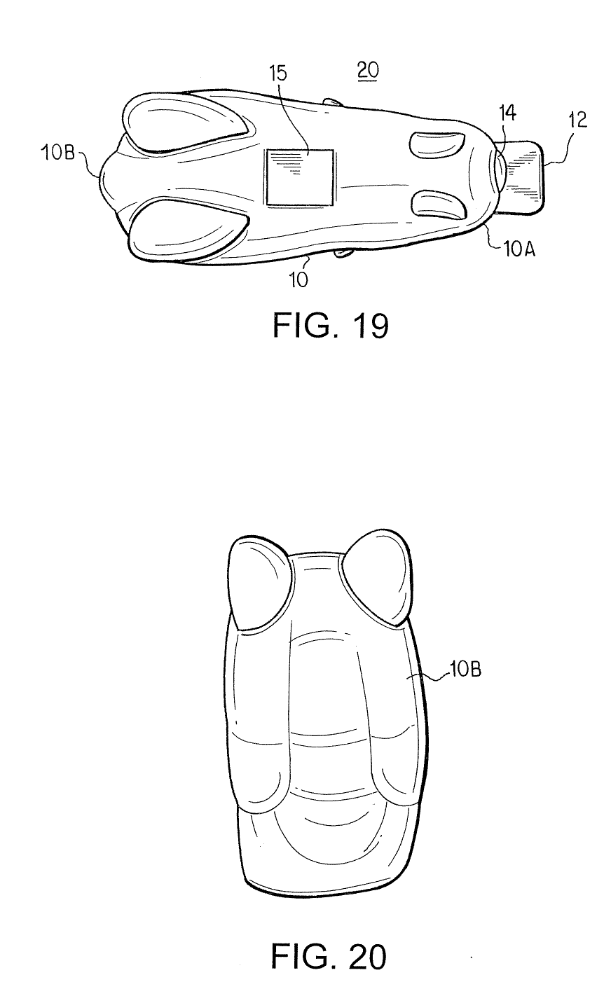

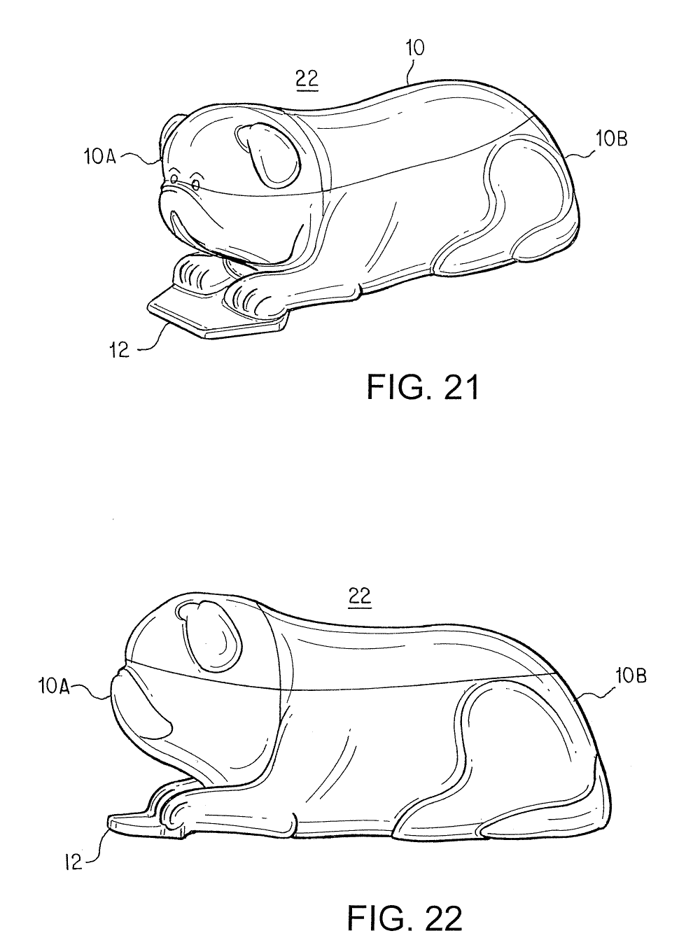

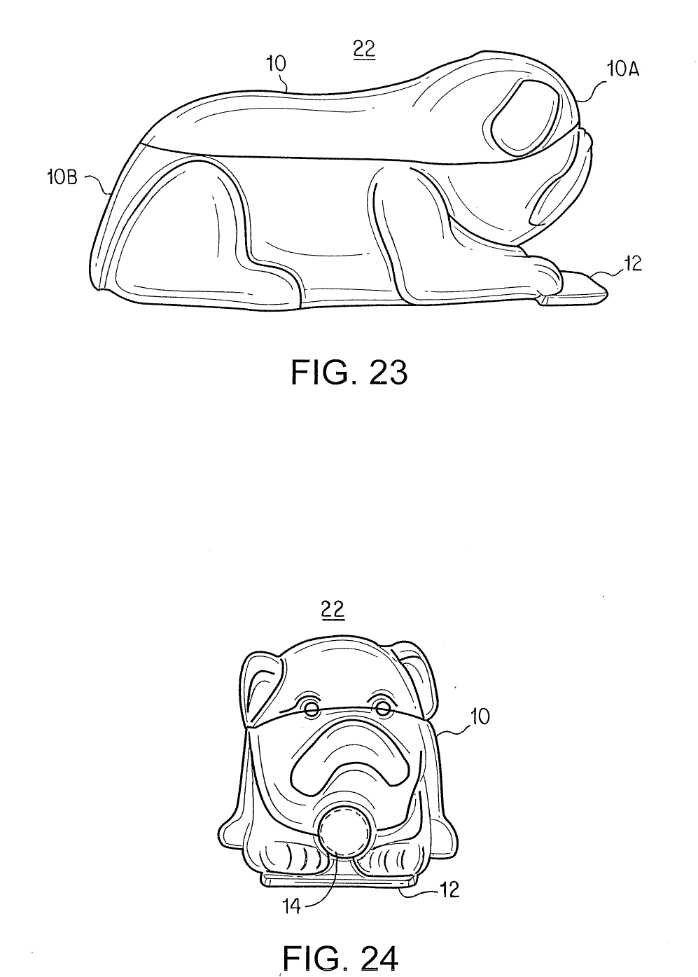

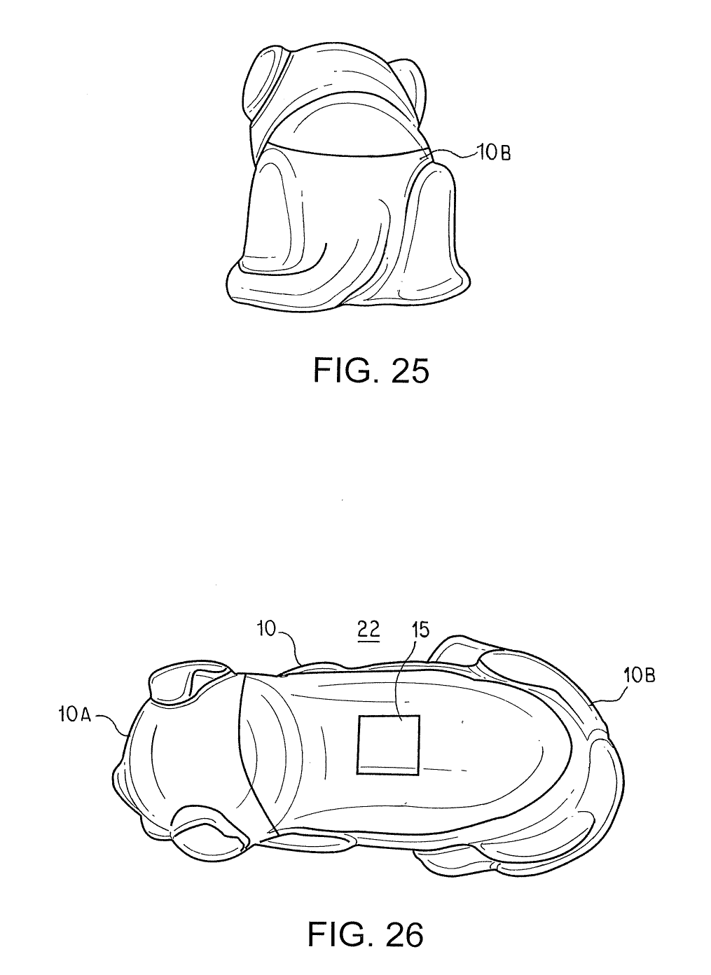

The finger-grip body 10 can bear the shape of an icon. By way of non-limiting examples, the character of the finger-grip body 10 is a symbol of greed or a farm animal, such as shown in the pig 16 of FIGS. 1-7. Another non-limiting example for the character of the finger-grip body 10 is a symbol of fortune, such as shown by the example of a poker chip 18 in the example of FIGS. 8-14. Yet another non-limiting example for the character of the finger grip body 10 is a sports mascot, in this instance an alligator head 20 in the examples FIGS. 15-20. In still another example of a character of the finger grip body is the bulldog 22 of FIGS. 21-26.

Still other examples of the character of the finger-grip body 10 include, but are not limited to is a symbol of luck (e.g., black cat with front paws as scratching tool, gambling or luck (e.g., rabbit's foot, four leaf clover), a symbol of a year of birth (e.g., a rat symbolizing the Year of the Rat), a mythical symbol (e.g., shamrock, leprechaun, etc.), a religious symbol (e.g., a guardian angel, Jesus, Buddha, etc.), or pretty much any other character or icon with which a user has or may have an affinity.

The lottery ticket scratchers of FIGS. 1-26 also include the scratching tool 12, which can have any suitable shape for scratching off the opaque film, such as a tab having a curved edge distal to the finger-grip body 10, or a tab 12 having a substantially straight edge distal to the finger-grip body 10. The tab 12 can be shaped like teeth, feet, nose of the character, etc. to add to the overall image of the character, but the tab 12 does not have to be part of the image of the character.

The light source 14 of the lottery ticket scratcher 1 is preferably one of an LED and/or a light bulb, but any suitable light emitting source (neon, fluorescent, etc.) can be used. Not shown in FIGS. 1-26, a compartment is provided on the interior of the lottery scratcher 10 for a battery or other source of power for the light, as may be conventional to the selected type of light. The light source 14 can be conceptually distinct from the character, but it can be part of or enhance the overall appearance, such as might be implemented by a pair of LEDs mimicking eyes of the character of an animal or other creature, flame of a dragon, the “inner light” of a mythological creature or religious symbol, such as an angel. It can be white, any color, multiple colors, changing colors, UV (black) light, etc. While in some embodiments light might shine to a degree through the body 10 such that the body 10 glows, the light will be sufficient to illuminate the distal end of the scratching tool 12. In other embodiments, the light might project enough to act as a miniature flashlight, illuminating well beyond the distal end of the scratching tool 12. Of course, various combinations can be achieved using the teachings herein.

The light source 14 can be activated using a switch 15, in which the body is pliable, and upon being squeezed, a circuit between the light source 14 and a battery (not shown) is completed. Squeeze switches, push-bottom switches, slide switches, and other bi-stable or mono-stable switches can be used. Alternatively or additionally, the light activating switch 15 is activated by engaging the scratching tool on a surface through, e.g., a spring loaded or biased switch that completes a circuit between battery and light source 14 upon the scratching tool 12 being displaced by a scratching action.

Though not required for every embodiment, the lottery ticket scratcher can include an attachment portion (e.g., eyelet) 10C for attaching a key chain 11 at the second end of the finger-grip body 10. The attachment portion 10C may in some embodiments be for attaching a lanyard at the second end 10B.

In yet another variation, the lottery ticket scratcher can include a plurality of bristles at one of first end and said second end. The bristles are shaped as one of: facial hair of a character, teeth of a character, wings of a character, and a mane or tail of a character.

It is also envisioned that combination the lottery ticket scratcher 10 and package 13 for a plurality of lottery tickets (not illustrated) can be sold as a single item for securing the lottery ticket scratcher 10 and one or more lottery tickets together. This is would a perfect combination gift to a lottery player. For instance, a first holder portion of the package 13 holds one or more lottery tickets, and another attachment portion 13A fastens the lottery ticket scratcher to the holder portion. The package 13 can hold one or more lottery tickets and the lottery ticket scratcher 10.

### Pig Exemplary Embodiment

FIGS. 1-7 illustrate perspective top, bottom, side, front and rear views of an embodiment of the lottery ticket scratcher shaped in the form of a pig. As will be understood, the pig shape can house batteries and lights that project through the first end 10A shaped in the form of the pig's snout. Also, this end 10A is the scratcher 12. On the opposite side at the second distal end is an optional aperture 10C for holding a lanyard, or the like. The finger grouping body 10 fits comfortably in the hand for control by the thumb or index finger, for example, of a switch 14. As illustrated, the switch 14 a squeeze push switch, but it can be indicia or embossment indicating the location of a squeeze switch or other light-activating type of switch. The design is cute but can be viewed as a symbol of greed or gluttony.

### Poker Chip Exemplary Embodiment

FIGS. 8-14 illustrate a poker chip embodiment that has a tab 12 adjacent to a light 14 on an edge of the poker chip. The tab 12 can be omitted since the edge of the chip can act as the scratcher. A switch 16 activates a light 14 in the illustrated exemplary embodiment, but an alternative is shown in which a push switch 16A is positioned on the edge, albeit at 90 degrees relative to the light in this particular embodiment. Other configurations can be envisioned without departing from the basic structure of a poker chip.

At a second end opposite to the light 14 can be apertures for holding a lanyard. In this illustrated embodiment, the lanyard can be threaded through a u-shaped aperture for holding a lanyard to the edge of the poker chip.

The poker chip embodiment 18 is advantageous insofar as it can readily accept embossments, printing or inserts identifying various establishments such as company logos, gaming house, casinos or any number of other identifying or symbolic information on the flat surface or surfaces. Though not illustrated in the embodiment, an insert in the form of a stiff plastic disk can be snapped into a groove ringing the outer most surface of the poker chip to show indicia. In this manner, a standard poker chip shape can be mass produced and a variety of inserts bearing the indicia, engravings or embossments of various designs can be separately made and assembled upon demand.

### Alligator Exemplary Embodiment

With respect to FIGS. 15-20, an alligator-shaped exemplary embodiment is shown. The snout of the alligator 20 can act as a scratching tool but in the illustrated embodiment, a tab 12 is shown. The alligator's nostrils can be apertures for the light source 14 but as illustrated, the light source 14 is positioned at the alligator's mouth in this embodiment. The body 10 of the alligator is easily gripped by fingers of a human hand and a central portion of it, or alternatively forehead portion, if pliable, can be used as part of the squeeze switch, for example, but in the illustrated embodiment, it is a push switch 15 in the alligator's forehead. The second end 10B of the finger grip body 10 can have an aperture for accepting a lanyard, keychain or the like, though not shown.

In this instance, the alligator can be a sports symbol or mascot for the Florida Gators™, for instance.

Of course, each of the embodiments can have a variety of colors and textures without departing from the scope of the present invention. Surface indicia, colorations, embossments and engravings, e.g., the name of the owner, company, association, team, etc., messages such as best wishes, mottos and the like, can be included on the finger grip body 10.

Although various embodiments of a lottery ticket scratcher and the method of using the same have been described in the foregoing specification with considerable details, it is to be understood that modifications may be made which do not exceed the scope of the appended claims, which encompass modified forms of the various embodiments, as will be apparent to others skilled in the art.

### Bulldog Exemplary Embodiment

FIGS. 21-26 illustrate a bulldog embodiment (e.g., a mascot of the Georgia Bulldogs™) which also includes a light switch 16, in this instance exemplary light switch being a push switch 15 shown in FIG. 26. The eyes of the bulldog can be light elements, but in this instance it is the mouth area which has a single light element 14. In this particular illustration, an eyelet for a lanyard is not included, although of course it could be. The front paws of the dog form a scratching tool by connecting the “toes” of the two feet together in a finger-grip bar 12. Though not illustrated, the tail of the dog can be suitable for holding a lanyard or the like if the tail is caused to be separated somewhat from the body so as to form a loop or hook.

What is claimed is:

1. A lottery ticket scratcher with light, comprising:
a finger-grip body having a first end and a second end;
a scratching tool positioned adjacent said first end with a scratching edge dimensioned to scratch off an opaque surface layer on a lottery ticket; and
a light positioned at said first end and positioned to project light in a working space adjacent said scratching tool.

2. The lottery ticket scratcher of claim 1, wherein said finger-grip body bearing the shape of a character.

3. The lottery ticket scratcher of claim 2, wherein the character of the finger-grip body is a symbol of luck.

4. The lottery ticket scratcher of claim 2, wherein the character of the finger-grip body is a symbol of fortune.

5. The lottery ticket scratcher of claim 2, wherein the character of the finger-grip body is a symbol of greed.

6. The lottery ticket scratcher of claim 2, wherein the character of the finger-grip body is a symbol of a year of birth.

7. The lottery ticket scratcher of claim 2, wherein the character of the finger-grip body is a religious symbol.

8. The lottery ticket scratcher of claim 2, wherein the character of the finger-grip body is an icon with which a user has an affinity.

9. The lottery ticket scratcher of claim 1, wherein the scratching tool is one of a tab having a curved edge distal to said finger-grip body, a tab having a substantially straight edge distal to said finger-grip body, and a sharp edge of the finger-grip body.

10. The lottery ticket scratcher of claim 1, wherein the light is at least one of: an LED and a light bulb.

11. The lottery ticket scratcher of claim 2, wherein the light is a pair of LEDs symbolizing a part of the character.

12. The lottery ticket scratcher of claim 1, further comprising a light activating switch.

13. The lottery ticket scratcher of claim 11, wherein the light activating switch is one of a push switch, squeeze switch and slide switch.

14. The lottery ticket scratcher of claim 1, wherein the light activating switch is activated by engaging the scratching tool on a surface.

15. The lottery ticket scratcher of claim 1, further comprising an attachment portion for attaching a key chain or lanyard at said second end.

16. The lottery ticket scratcher of claim 1, further comprising a plurality of bristles at one of said first end and said second end.

17. The lottery ticket scratcher of claim 16, wherein the bristles are shaped as one of: facial hair of a character, teeth of a character, wings of a character, mane of a character and a tail of a character.

18. A combination comprising:
the lottery ticket scratcher of claim 1; and
a package for securing said lottery ticket scratcher and one or more lottery tickets together.

19. The combination of claim 18, wherein a first holder portion of said package holds said one or more lottery tickets, and another attachment portion fastens said lottery ticket scratcher to said holder portion.

20. The combination of claim 18, wherein said package covers said one or more lottery tickets and said lottery ticket scratcher.
